(19) United States
(12) Patent Application Publication
(10) Pub. No.: US 2026/0140089 A1
(43) Pub. Date: May 21, 2026

(54) METHOD FOR THE INTERNAL INSPECTION OF STORAGE TANKS

(71) Applicant: PETROLEO BRASILEIRO S.A. - PETRBRAS, Rio de Janeiro (BR)

(72) Inventor: Marcelo De Deus Oliveira, Betim (BR)

(21) Appl. No.: 19/382,527

(22) Filed: Nov. 7, 2025

(30) Foreign Application Priority Data
Nov. 11, 2024 (BR) BR 1020240234332

(51) Int. Cl. G01N 29/04; B08B 9/46; B65D 88/08; B65D 88/34; B65D 90/00; B65D 90/48; G01B 17/02; G01N 27/82

(52) U.S. Cl. CPC G01N 29/04; B08B 9/46; B65D 88/08; B65D 88/34; B65D 90/0093; B65D 90/48; G01B 17/02; G01N 27/825; B08B 2209/08; G01N 2291/023; G01N 2291/02854; G01N 2291/0289; G01N 2291/267

(57) ABSTRACT

The present invention relates to a method for internal inspection of storage tanks containing a large volume of residual product and having a very short maintenance window, being applicable mainly in the inspection and maintenance activity of fixed-roof and floating-roof storage tanks, by any refinery or process plant that has a tank storage area (for example, refineries, terminals and petrochemical plants). The aforementioned method comprises installing a stainless-steel cylinder (1) within the storage tank to delimit a confined area inside the equipment, said area being cleaned and decontaminated so that it may subsequently undergo non-destructive thickness measurement and magnetic particle testing to determine the thickness of the bottom plates and to detect possible cracks in the weld seams of the bottom plates.

This application claims the benefit of priority to Brazilian Patent Application No. 1020240234332, filed Nov. 11, 2024, the entire contents of which are incorporated herein by reference.

### FIELD OF THE INVENTION

The present invention falls within the field of fuel supply and biofuels, more specifically in the field of maintenance and ease of supply and refers to a method for the internal inspection of storage tanks containing a large volume of waste and subject to very short maintenance downtime, being applicable to the inspection and maintenance of fixed roof and floating roof storage tanks.

### BACKGROUND OF THE INVENTION

Storage tanks are essential in oil refineries and logistics terminals. Despite its relatively simple design when compared to other equipment in the oil and gas industry, the costs involved in its maintenance are often high, in particular in older plants. Such equipment typically has a very long service life of around 25 years, and over this time there is a significant accumulation of residue that has be removed to allow internal inspection of the equipment.

However, the intervention period for equipment containing this type of product is then considerably long, lasting around 6 to 8 months depending on the tank diameter and the amount of accumulated residue. The methodology addressed herein was designed based on the need to carry out internal inspection within a very short period of time (around 4 months). For production logistics reasons, this equipment has become essential to allow for the scheduled shutdown of the process plant. Therefore, the intervention period for restoring this equipment back to operation was considerably reduced from 8 to 4 months. This need has created a huge challenge due to the short time available for cleaning and inspecting the interior of the equipment.

### STATE OF THE ART

Some prior art documents present solutions for the inspection and/or cleaning of storage tanks used in the oil and gas industry, for example:

Document FR2636406A1 refers to a new type of storage tank for gas fuels, such as propane, which has an automatic control system that covers its entire external surface and can be checked remotely. This means the tank can be monitored and controlled more efficiently and safely, ensuring no leaks or safety issues. Such an innovation is important for the fuel storage industry as it increases tank reliability and efficiency.

WO1996007093A1 relates to a method and a device for examining the condition of the bottom wall surface in oil tanker tanks without the need for removal of a lower part of the outlet pipe. The method involves introducing a camera through a narrow opening between the inlet end of the pipe and the wall surface, illuminating the wall surface, and transmitting signals to a remote location that represent a visual image of the wall. This allows for accurate and easy inspection of the wall surface without the need to remove the outlet pipe.

Document U.S. Pat. No. 5,757,419A relates to a device for remotely inspecting the interior of a storage tank. It includes an articulated arm which extends into the tank through an access opening and moves along the tank axis. A camera attached to the arm can rotate 360 degrees to scan the entire internal circumference of the tank. This device is new as it allows for an efficient and full tank inspection without the need for a workman to enter the tank, reducing the risks and costs associated with tank inspection.

However, none of the documents proposes the solution described in the present invention, that is, the installation of a stainless-steel cylinder inside the storage tank in order to delimit a small area inside the equipment, which must be cleaned and decontaminated, to then receive the non-destructive thickness measurement test. The solutions proposed in such prior-art documents are generally based on holistic processes, that is, an analysis is made from the origin of the specific problem to the impacts it may cause and, from there, actions are proposed to overcome such potential issues in an already existing process. That is, the solutions achieved are proposed according to the reality, specificity and context of the moment. In the present invention, the proposed solution is intended to address most of the issues that may arise throughout the service life of storage tanks, minimizing their impacts as much as possible, whereas in the selected prior arts the solutions are directed to specific problems, providing targeted and limited results for those particular situations.

### SUMMARY OF THE INVENTION

The present invention relates to a method for enabling the internal inspection of storage tanks containing large volumes of residue and subject to very short maintenance periods, said method being applicable to any refinery or process plant comprising a tanking area (such as refineries, terminals, or petrochemical plants). The aforementioned method comprises installing a stainless-steel cylinder (1) within the storage tank to delimit a confined area inside the equipment, said area being cleaned and decontaminated so that it may subsequently undergo non-destructive thickness measurement and magnetic particle testing to determine the thickness of the bottom plates and to detect possible cracks in the weld seams of the bottom plates.

### BRIEF DESCRIPTION OF THE FIGURES

FIG. 1 shows a side view of the stainless-steel cylinder (1) used in the proposed method.

FIG. 2 shows a top view of the stainless-steel cylinder (1) used in the proposed method.

FIG. 3 shows a top view of the storage tank (2) showing the cylinders (1) placed inside it.

FIG. 4A and FIG. 4B show photographs showing the interior of the storage tank containing a large volume of residue.

FIG. 4C shows the stainless-steel cylinder mounted inside the storage tank. FIG. 4D shows the area previously delimited by the cylinder duly treated.

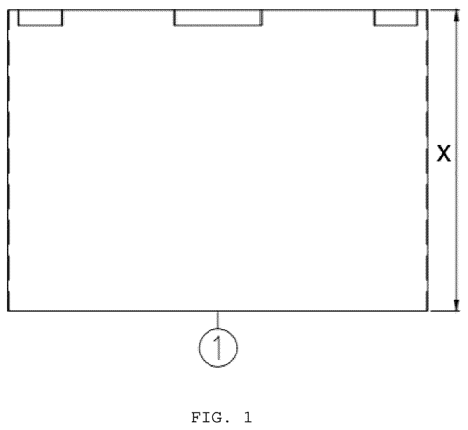

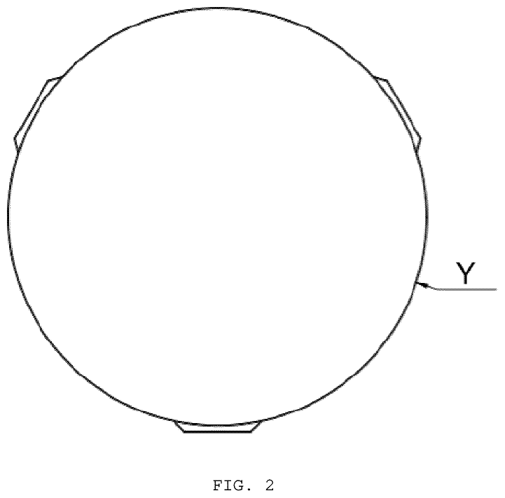

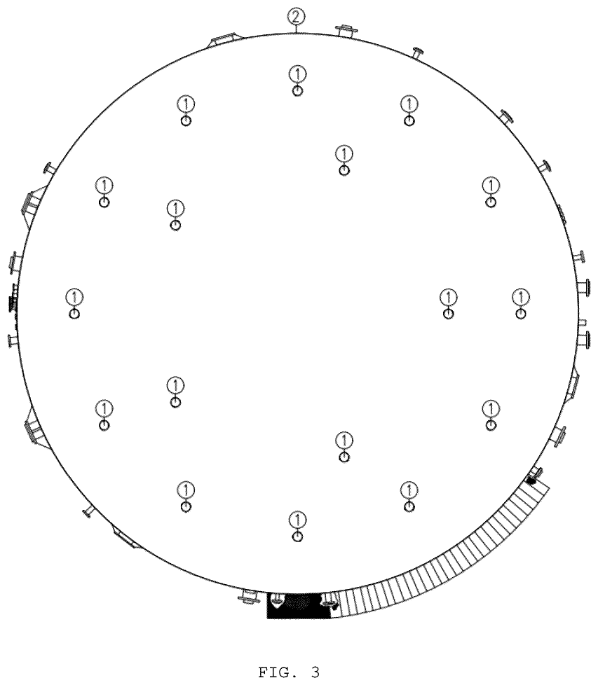

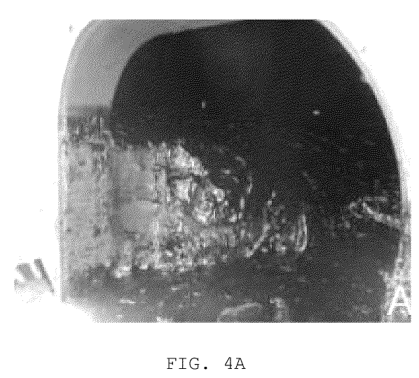

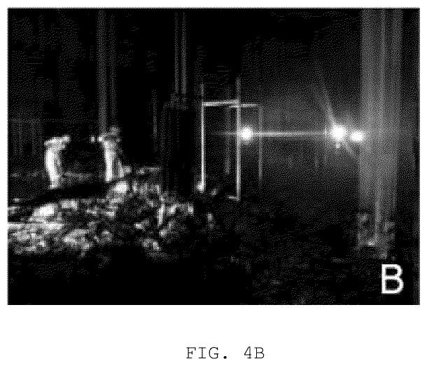

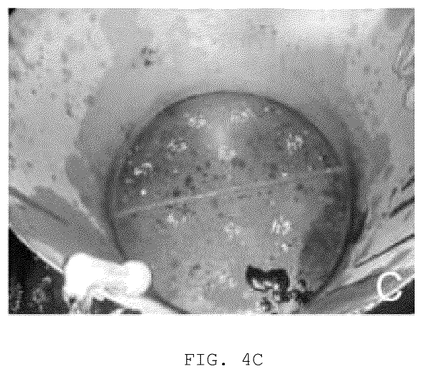

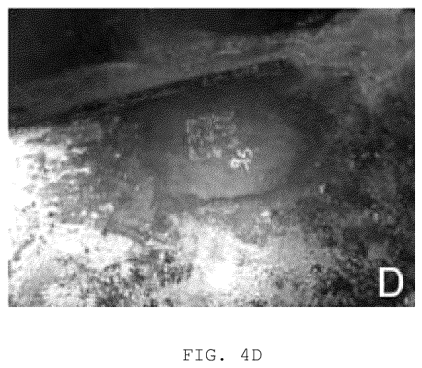

### DETAILED DESCRIPTION OF THE INVENTION

The present invention relates to a method for performing internal inspection of storage tanks containing a large amount of residue and subject to a short maintenance downtime, comprising the installation of a stainless steel cylinder (1) inside the storage tank (2), after opening, while it still contains residue, in order to delimit a small area inside the equipment, which must be cleaned and decontaminated, so that it can then be subjected to non-destructive thickness measurement and magnetic particle testing for measuring the thickness on the bottom plates and assessing possible cracks in the welding seams of the bottom plates.

Thickness measurement testing is a non-destructive testing method based on ultrasound waves for the internal detection of defects in materials or for measuring the thickness of the wall and detecting corrosion. Non-destructive magnetic particle testing uses magnetic particles, which are products developed from iron or iron oxide powder and have the property of being visible or fluorescent, as a dry powder or diluted in prepared solutions. These particles are used to detect surface or subsurface discontinuities in ferromagnetic materials and are designed to be used in Magnetic Particle Inspection. This testing method makes it possible to detect surface and subsurface discontinuities in ferromagnetic materials (the material can be magnetized).

Such procedures will be repeated a number of times and in different locations until a representative sample is obtained to allow a consistent and reliable technical analysis by inspecting equipment regarding the conservation status of the bottom plating of the storage tank. Such analysis carried out by technicians in the equipment inspection field will indicate whether or not repairs are required and also the remaining service life of the equipment.

Said cylinder is open at both ends, having sizes that allow a person of average size to enter it and clean its lower portion (tank bottom plate). The cylinder is 800 mm in height (x) and 1120 mm in diameter (y) on average.

The main idea of the proposed method is precisely to place the cylinder on top of the oily sludge and press it until it touches the bottom plate. After this step, the residue inside the cylinder is cleaned until the bottom plate marked by the cylinder is revealed. After the plate is revealed at the bottom, such small area is completely decontaminated from hydrocarbons, thus enabling the cited non-destructive testing by equipment inspection, in this instance the thickness measurement and magnetic particle testing.

The following data show, by way of example, the success in applying the method proposed in the present invention.

### EXAMPLE OF THE INVENTION

In order to demonstrate its efficacy, the proposed method was successfully applied to a fuel oil tank, where the original schedule estimated approximately eight months for completion, including four months dedicated solely to internal cleaning. This would result in a total equipment downtime of four months. By employing the proposed method, only partial internal cleaning was performed, while internal inspection was performed using a representative set of thickness measurement points covering multiple regions within the tank. This approach provided a consistent and reliable technical basis to predict the remaining service life of the equipment and to release it back into operation for an additional operational cycle. The return of the storage tank to operation made it possible to maintain the scheduled maintenance outage of the process plant as agreed with the areas involved.

Below, an inspection report is presented, which demonstrates the applicability of the proposed method and makes it possible to make an internal inspection along with an internal cleaning of the equipment. Without the method, the report would not have been issued within the required timeframe.

### Inspection Report

The tank that stores fuel oil has dimensions of 45.7 m long and 14.6 m high. The average residual sludge level is 700 mm, making an average sludge volume of 1,148 m³.

This tank was cleared with great difficulty, and the inspection took place in parallel with the cleaning due to the amount of diluted sludge. As a result, there were several drawbacks to a highly effective inspection. It should be noted that this tank has been out of operation several times over the past 3 years, during which dilution of the sludge (heavy hydrocarbon+UFCC catalyst) has been attempted in various ways. Such dilution was not sufficient to remove all the sludge from the bottom, making it necessary to open it and mechanically remove it to clear sample areas for bottom inspection.

In the current internal and external inspection, visual inspection was carried out, ME of the roof and shell was carried out at the control points and by sampling at the tank bottom. Magnetic particle testing was made on the nozzles and the bottom welds for sampling, on the squeegee on the internal side and on the external side (with the insulation removed). TH was also performed on the coils and removal for inspection of the foam and vent chambers.

### OVERALL

Clearing this tank was complicated since the product stored in it has a large amount of catalyst. A 700 mm high layer of sludge that could not be diluted had to be removed manually by opening the PL and using a shovel, wheelbarrow and diluent. Since the outage for this tank was limited to the start of the CQ-HDT shutdown, the inspection had to be carried out together with cleaning. Even so, there was not enough time to completely clean the bottom, so it was inspected for:
Squeegee weld integrity: visual inspection and magnetic particle testing were only possible in regions that were cleaned;
Column support: cleaning was able to access only one of the roof columns;
Coil: pressure testing was performed only, passed:
Roof: It was not possible to install a sufficient number of reflectors to perform an adequate visual inspection of the roof;
Bottom: it was not possible to perform a MFL test to ensure the absence of external corrosion, nor was it possible to cut and weld bottom plates with the remaining product. Rings were used to carefully isolate and clean regions of ø 1 m for visual inspection and ME;
Shell: a partial assessment was made of where access was

possible, without any signs of severe corrosion. The type of product stored adheres to the shell and creates a protective layer against corrosion. Thickness measurement was carried out at the control points, with no representative corrosion rate;
Drains: were not assessed in this inspection;
Discharge: It was not assessed in this inspection;

### BOTTOM

The bottom was partially inspected in parallel with the cleaning of the tank. For the visual and MP testing of the plates, several regions were prepared using ø 1 m rings, where cleaning was more thorough. All cleaned and ME-tested regions presented nominal thickness, and the plate appeared to be new. The minimum thickness of the cut plate was 6.2 mm and that of the annular plate was 9.2 mm.

Furthermore, PM testing was performed on the overlap welds in these clean areas, and no defects were detected.

In the region near the northwest BV, after removal of thermal insulation, a small seepage of product was identified beneath the bottom plate and above the concrete ring, and it was monitored throughout the outage. The leakage was cleaned several times, yet it reappeared the following day. An internal investigation was conducted to identify any weld defects, holes, or other discontinuities that could explain the leakage, but none were found. Finally, breakage of the concrete ring was requested to expose the bottom plate as much as possible. After it was broken, no leakage was detected during one day of monitoring and then a small amount of diesel was added to the inside in an attempt to check for any new leaks. No leakage was detected, suggesting that the prior leakage may have been the result of the large volume of diluent used to clean the northwest BV, which could have penetrated and remained in the gap with the bottom plate. Furthermore, no indication of leakage was found at any locations opened for inspection of the squeegee.

The measured bottom plate thickness values were used for corrosion rate assessment and Risk-Based Inspection (RBI) of this equipment. The results, as presented in the Risk-Based Inspection (RBI) report for tank 0027-TQ-00961, indicated that the bottom plate will only reach a medium-high risk level, i.e., attain the target Damage Factor (DF) of 1000, in 2035.

Moreover, the proposed method allows a significant reduction in the equipment inspection timeframe, since it allows inspection of the equipment bottom plate even without having removed all the residual product, which could only be carried out in the traditional procedure after full removal of the residue and hydrocarbon decontamination. In this instance, the intervention period made available by the operation (4 months) is reached, thus allowing the scheduled shutdown of the process plant as per initial planning.

It is important to highlight that the proposed method reduces the exposure of personnel hired to remove residue, significantly increasing the safety of the operation due to the reduced time required for cleaning activities. In this way, it is possible to meet all requirements related to productivity, techno-economic efficiency, and safety.

Among the main advantages achieved with the present invention, the following stand out:
Reduction of man-hours exposed to risk and increased equipment availability during maintenance.
Reduction of the specific cost projected for equipment maintenance and increased productivity due to the decreased inherent risks associated with work inside the equipment.
Protection and preservation of the health and physical integrity of the executing personnel.
Given the time constraint, the proposed method adds reliability by enabling the inspection to be performed within the planned 4-month period, in accordance with the plant's equipment inspection requirements, thereby allowing the equipment to return to operation with consistent integrity inspection results.
Reduction of the internal inspection period, thereby optimizing intervention time in the tank farm to allow a greater number of equipment units to be inspected, preventing potential failures (leaks through the bottom and/or shell) due to lack of inspection, and consequently avoiding environmental contamination.

1. A method for internal inspection of a storage tank containing a large volume of residual product and having a very short maintenance window, wherein the method comprises the following steps:
(a) installing a stainless-steel cylinder (1) inside the storage tank (2), after it has been opened and still containing the residual product, wherein said cylinder is placed on top of an oil sludge and pressed until it touches a bottom plate;
(b) cleaning the residual product contained inside the cylinder until the bottom plate delimited by the cylinder is revealed, followed by full decontamination from hydrocarbons of the delimited area; and
(c) carrying out a non-destructive thickness measurement and a magnetic particle testing to measure the thickness of the bottom plates and check for possible cracks in weld seams of the bottom plates.

2. A method according to claim 1, wherein said cylinder has an average height of 800 mm and a diameter of 1120 mm, and is open at both ends, allowing a medium-sized person to enter and perform cleaning at its bottom section.

3. A method according to claim 1, wherein the thickness measurement testing is a non-destructive testing method based on ultrasound waves for detecting internal defects in materials or for measuring the thickness of a wall and detecting corrosion.

4. A method according to claim 1, wherein the non-destructive magnetic particle testing employs magnetic particles developed from iron powder or iron oxide having a property of being either visible or fluorescent, as a dry powder form or diluted in prepared solutions, wherein said method is used for detecting surface and subsurface discontinuities in ferromagnetic materials.

5. Use of the method as defined in claim 1, wherein it is mainly in an inspection and maintenance activity of fixed roof and floating roof storage tanks.
